(19) United States
(12) Patent Application Publication
(10) Pub. No.: US 2026/0359325 A1
(43) Pub. Date: Nov. 12, 2026

(54) Context Processing and Modification for Large Language Models

(71) Applicant: GDM Holding LLC, Mountain View, CA (US)

(72) Inventors: Florian Nils Hartmann, Zurich (CH); Matthew Sharifi, Kilchberg (CH)

(21) Appl. No.: 19/205,553

(22) Filed: May 12, 2025

(51) Int. Cl. G06F 16/28; G06F 16/22; G06F 40/284

(52) U.S. Cl. CPC G06F 16/285; G06F 16/2282; G06F 40/284

(57) ABSTRACT

Methods, systems, devices, and non-transitory computer readable media for processing contexts are provided. The disclosed technology can include receiving query data comprising a query and context item associated with the query. The query data can comprise tokens based on the query and the context item. Based on comparing the query to an attention index, a relevant query cluster that satisfies a similarity threshold of the query can be determined. The attention index can be based on historical queries associated with historical tokens and corresponding portions of the context item. Based on the tokens associated with the relevant query cluster, relevant tokens comprising the historical tokens associated with the historical attention scores that satisfy attention criteria can be determined. Based on inputting the relevant tokens into a machine-learned model, results associated with the query can be determined. Further, result data based on the results can be generated.

### FIELD

The present disclosure relates generally to improving the processing of queries and contexts. In particular, the present disclosure relates to improving the efficiency with which computational resources associated with machine-learned models processing contexts are used by generating query clusters based on historical queries and pre-computed attention scores.

### BACKGROUND

Machine-learned models can be used for a variety of purposes including generating responses to queries. The resources involved in generating responses to queries can vary based on the complexity of the query and the amount of data associated with the query. A greater amount of data associated with a query can result in a greater use of computational resources and increased latency due to the greater amount of data that is processed. However, increasing the computing resources can be expensive and reducing the complexity of queries can result in suboptimal results. As such, attempting to improve the performance of computing systems that process queries and the data associated with the queries can present challenges. Accordingly, there may be different approaches to processing queries and the data associated with the queries.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of processing contexts used by machine-learned models. The computer-implemented method can comprise receiving, by a computing system comprising one or more processors, query data comprising a query and a context item associated with the query. The query data can comprise a plurality of tokens based on the query and the context item. The computer-implemented method can comprise determining, by the computing system, based on comparing the query to an attention index comprising a plurality of query clusters and a plurality of historical attention scores associated with the plurality of query clusters, a relevant query cluster that satisfies a similarity threshold of the query. The plurality of query clusters can be based on a plurality of historical queries associated with a plurality of historical tokens and a corresponding plurality of portions of the context item. The computer-implemented method can comprise determining, by the computing system, based on the plurality of tokens associated with the relevant query cluster, a plurality of relevant tokens comprising the plurality of historical tokens associated with the plurality of historical attention scores that satisfy one or more attention criteria. The computer-implemented method can comprise determining, by the computing system, based on inputting the plurality of relevant tokens into one or more machine-learned models, one or more results associated with the query. The computer-implemented method can comprise generating, by the computing system, result data based on the one or more results associated with the query.

Another example aspect of the present disclosure is directed to one or more tangible non-transitory computer-readable media storing computer-readable instructions that when executed by one or more processors cause the one or more processors to perform operations.

The operations can comprise receiving query data comprising a query and a context item associated with the query. The query data can comprise a plurality of tokens based on the query and the context item. The operations can comprise determining, based on comparing the query to an attention index comprising a plurality of query clusters and a plurality of historical attention scores associated with the plurality of query clusters, a relevant query cluster that satisfies a similarity threshold of the query. The plurality of query clusters can be based on a plurality of historical queries associated with a plurality of historical tokens and a corresponding plurality of portions of the context item. The operations can comprise determining, based on the plurality of tokens associated with the relevant query cluster, a plurality of relevant tokens comprising the plurality of historical tokens associated with the plurality of historical attention scores that satisfy one or more attention criteria. The operations can comprise determining, based on inputting the plurality of relevant tokens into one or more machine-learned models, one or more results associated with the query. The operations can comprise generating result data based on the one or more results associated with the query.

Another example aspect of the present disclosure is directed to a computing system comprising: one or more processors; one or more non-transitory computer-readable media storing instructions that when executed by the one or more processors cause the one or more processors to perform operations. The operations can comprise receiving query data comprising a query and a context item associated with the query. The query data can comprise a plurality of tokens based on the query and the context item. The operations can comprise determining, based on comparing the query to an attention index comprising a plurality of query clusters and a plurality of historical attention scores associated with the plurality of query clusters, a relevant query cluster that satisfies a similarity threshold of the query. The plurality of query clusters can be based on a plurality of historical queries associated with a plurality of historical tokens and a corresponding plurality of portions of the context item. The operations can comprise determining, based on the plurality of tokens associated with the relevant query cluster, a plurality of relevant tokens comprising the plurality of historical tokens associated with the plurality of historical attention scores that satisfy one or more attention criteria. The operations can comprise determining, based on inputting the plurality of relevant tokens into one or more machine-learned models, one or more results associated with the query. The operations can comprise generating result data based on the one or more results associated with the query.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

FIG. 1 depicts a block diagram of examples of operations performed by a context processing system according to example embodiments of the present disclosure;

FIG. 2 depicts an example of an interface that displays results that were generated based on a query and context according to example embodiments of the present disclosure;

FIG. 3 depicts an example of a computing device according to example embodiments of the present disclosure;

FIG. 4 depicts a flow chart diagram of an example method of processing contexts according to example embodiments of the present disclosure;

FIG. 5 depicts a flow chart diagram of an example method of processing contexts according to example embodiments of the present disclosure; and

FIG. 6 depicts a flow chart diagram of an example method of processing contexts according to example embodiments of the present disclosure;

FIG. 7 depicts a flow chart diagram of an example method of processing contexts according to example embodiments of the present disclosure;

FIG. 8 is a flow chart diagram illustrating an example method for training a machine-learned model according to example implementations of aspects of the present disclosure;

FIG. 9 is a block diagram of an example processing flow for using machine-learned model(s) to process input(s) to generate output(s) according to example implementations of aspects of the present disclosure;

FIG. 10 is a block diagram of an example sequence processing model according to example implementations of aspects of the present disclosure;

FIG. 11 is a block diagram of an example technique for populating an example input sequence for processing by a sequence processing model according to example implementations of aspects of the present disclosure;

FIG. 12 is a block diagram of an example model development platform according to example implementations of aspects of the present disclosure;

FIG. 13 is a block diagram of an example training workflow for training a machine-learned model according to example implementations of aspects of the present disclosure;

FIG. 14 is a block diagram of an inference system for operating one or more machine-learned model(s) to perform inference according to example implementations of aspects of the present disclosure;

FIG. 15 is a block diagram of an example networked computing system according to example implementations of aspects of the present disclosure;

FIG. 16 is a block diagram of an example computing device according to example implementations of aspects of the present disclosure; and

FIG. 17 is a block diagram of an example computing device according to example implementations of aspects of the present disclosure.

### DETAILED DESCRIPTION

In general, the present disclosure is directed to processing queries (e.g., search queries) and the contexts (e.g., context items comprising video context, image context, textual context, audio context, and/or audio-video context) associated with the queries. In particular, the queries and/or contexts can be processed for use in tasks including semantic searches that can be used to generate relevant results based on queries and related context. In particular, the disclosed technology can improve the performance and/or efficiency of operations to generate relevant search results by generating an attention index that includes clusters of queries and/or attention scores that are arranged such that similar queries are clustered together. Further, the disclosed technology can dynamically update the attention index based on adding new queries to existing clusters or generating new clusters based on new queries that are sufficiently different from existing clusters.

The disclosed technology can include a computing system that receives query data that includes a query and/or context item associated with the query. For example, the query data can be received from a smartphone that implements a search application and comprise a query requesting information about a context item comprising an audio-video clip. The computing system can then determine a relevant query cluster that satisfies a similarity threshold of the query. Determination of the relevant query cluster can be based on comparing the query to an attention index comprising a plurality of query clusters and a plurality of historical attention scores associated with the plurality of query clusters. Further, the plurality of query clusters can be associated with a plurality of historical tokens and a corresponding plurality of portions of the context item. For example, the attention index can be based on historical queries associated with portions of a video clip that were previously searched by other users and/or the same user at a previous time. The relevant query cluster can indicate the relevance of the query with respect to a query cluster that satisfies a similarity threshold of the query. In some implementations, the attention index can comprise a plurality of query cluster embeddings that are based on the plurality of query clusters and determination of the relevant query cluster can be based on comparison of a query embedding (based on the query data) to the plurality of query cluster embeddings.

Based on the plurality of tokens associated with the relevant query cluster, the computing system can determine a plurality of relevant tokens that comprise the plurality of historical tokens associated with the plurality of historical attention scores that satisfy one or more attention criteria. For example, the plurality of relevant tokens can comprise the plurality of relevant tokens associated with historical attention scores that exceed an attention score threshold. The computing system can then determine, based on inputting the plurality of relevant tokens into one or more machine-learned models, one or more results associated with the query. For example, the plurality of relevant tokens can comprise the tokens associated with higher attention scores that are more relevant to a query requesting specific information about wolves with reference to a context item comprising a video segment (e.g., a video clip from a streaming video website) about wolves. The plurality of relevant tokens can be inputted into one or more machine-learned models that are configured and/or trained to generate one or more results that are related to the query and comprise an analysis of the relevant portions of the video segment that include wolves.

The computing system can then generate result data based on the one or more results associated with the query. For example, the result data can comprise the one or more results and/or indications associated with portions of the context item (e.g., the time intervals of a video clip and/or the specific pages and/or paragraphs in an article or book). In some embodiments, the result data can be outputted via an interface (e.g., a graphical user interface).

As such, the disclosed technology can be used to perform a variety of technical tasks including generating an attention index that can be used to process queries and contexts (e.g., context items) more effectively and dynamically updating the attention index based on new queries and/or contexts (e.g., new context items).

The disclosed technology can be implemented in a computing system (e.g., a context processing computing system) that is configured to access data and/or perform operations on the data. For example, the operations performed by the computing system can comprise receiving query data comprising a query and a context item, determining a relevant query cluster that satisfies a similarity threshold of the query, determining tokens comprising the historical tokens associated with attention scores that satisfy attention criteria, determining results based on inputting the relevant tokens into the machine-learned models and/or generating result data based on the results associated with the query.

The computing system can be included as part of a system that includes a server computing device that receives data comprising query data from a client computing device, performs operations based on the data and sends output comprising result data back to the client computing device. In some embodiments, the computing system can include specialized hardware and/or software that enables the performance of operations specific to the disclosed technology. For example, the computing system can include one or more application specific integrated circuits and/or neural processing units that are configured to perform operations associated with the processing of query data comprising a query and/or context (e.g., a context item), and which can be used to assist a user in the tasks of search, query processing, context processing, result generation, and/or data retrieval.

The computing system can receive and/or obtain query data. The query data can comprise one or more queries and/or one or more context items (e.g., one or more contexts). The one or more queries can be associated with the one or more context items. For example, the computing system can receive query data comprising a query requesting information associated with a portion of a context item comprising a passage in journal article that indicates “EXPLAIN THE CHAPTERS IN THE BOOK THAT DISCUSS THE DISCOVERY OF ICELAND.” By way of further example, the computing system can receive query data comprising a query requesting information associated with a particular portion of a context item comprising a scene in a movie can indicate “AT WHAT POINT IN THE MOVIE DOES GEORGE MEET BONNY?”

Further, the query data can comprise a plurality of tokens based on the one or more queries (e.g., a query) and/or the one or more context items (e.g., a context item). Each token can be based on a unit or subunit of text (e.g., a word, sub-words including prefixes and/or suffixes, one or more characters including one or more letters and/or one or more numbers, and/or punctuation marks). For example, the query “TELL ME HOW TO RUN FASTER” which does not include punctuation can comprise the tokens “TELL,” “ME,” “HOW,” “TO,” “RUN,” “FAST,” and “ER,” which is seven units and/or subunits of text based on six words.

Further, the computing system can generate the plurality of tokens which can comprise a numerical representation of the units and/or subunits of text.

The query can comprise a text-based query (e.g., a query comprising text that can be provided via an input device which can include a keyboard). Further, a query can comprise a speech-based query (e.g., a query comprising speech that is provided via an audio input device which can include a microphone). Further, the query can be inputted via an interface (e.g., a graphical user interface) that can be implemented on the computing system and/or a computing device that can send the query and/or the query data to the computing system. In some embodiments, the query can be associated with a context item comprising a video segment or an audio-video segment. For example, the query can comprise a request for information about a context item comprising a movie or instructional video segment. Further, the corresponding plurality of portions of the context item can comprise one or more portions (e.g., one or more different portions) of the audio-video segment or video segment. For example, the context item associated with a query requesting information about a video segment can comprise one or more portions of the video segment.

In some embodiments, the query can be associated with a context item comprising a text segment. For example, the query can comprise a request for an explanation about a portion of a document comprising a book or journal article. Further, the corresponding plurality of portions of the context item can comprise one or more portions (e.g., different portions) of the document. For example, the context item associated with a query requesting a summarization and/or explanation of a journal article can comprise one or more portions of the journal article.

Further, a context item can comprise one or more documents (e.g., one or more documents retrieved using a retrieval augmented generation (RAG) system). Further, a context item can comprise various types of documents, one or more portions of which can be included as part of the query. Further, the query can comprise one or more references to one or more context items and/or a location at which a context item can be retrieved and/or obtained. For example, a query can comprise a link (e.g., a link to an Internet address) at which a context item comprising a document is stored. By way of further example, a query can comprise bibliographical information (e.g., the name and/or author of a document) that can be used to retrieve and/or obtain the context item.

The context item can comprise and/or be based on one or more contexts. For example, a context item can comprise context comprising one or more text segments (e.g., one or more documents), one or more images (e.g., images from an image repository), one or more audio segments (e.g., one or more audio clips from a music streaming service or a podcast service, and/or one or more video segments and/or one or more audio-video segments (e.g., one or more video clips from a video streaming service). Further, the context item can comprise and/or be based on various types of contexts and/or media. For example, the context can comprise different types of contexts (e.g., text and images).

A context window or a context length can indicate and/or be associated with a scope, span, amount, and/or number of the plurality of tokens that can be processed and/or used at one time (e.g., a number of tokens that can be used as an input to one or more machine-learned models and/or a number of tokens that can be used by the one or more machine-learned models to generate output). For example, the context window can indicate and/or be associated with the number of tokens that can be processed at one time to generate the relevant query cluster and/or the one or more results (e.g., the one or more results associated with the query). A size or length of the one or more queries and/or the one or more context items that can be processed by the one or more machine-learned models can be based on a context window. In some embodiments, the context window can have a fixed size (e.g., a predetermined number of the plurality of tokens that can be processed at one time). In some embodiments, the context window can have an adjustable size (e.g., a different number of the plurality of tokens can be processed based on the type or format of the query and/or context items).

In some embodiments, the context item can comprise one or more images. The one or more images can comprise images of various sizes, resolutions, image encoding formats, and/or color spaces. Further, the one or more images can comprise color images, black and white images, and/or grayscale images. The context item can comprise one or more text segments (e.g., one or more characters, words, sentences, paragraphs, and/or pages of text). For example, the context item can comprise one or more books, one or more articles, one or more email messages, one or more text messages, and/or one or more social media posts. The context item can comprise one or more video segments and/or one or more audio-video segments. The one or more video segments and/or one or more audio-video segments can comprise video segments of various resolutions, frame rates, and/or encoding formats; and/or audio segments of various bitrates and/or encoding formats. For example, the one or more video segments and/or one or more audio-video segments can comprise movies, television programs, and/or streaming media video clips. The context item can comprise one or more audio segments. Further, the one or more audio segments can comprise audio segments of various bitrates and/or encoding formats.

The computing system can determine and/or generate a relevant query cluster that satisfies a similarity threshold of the query. Determining the relevant query cluster can be based on comparing the query to an attention index comprising a plurality of query clusters and/or a plurality of historical attention scores associated with the plurality of query clusters. The attention index can be based on historical query data comprising a plurality of historical tokens based on a plurality of historical queries associated with a corresponding plurality of portions of the context item. The plurality of historical queries can comprise queries that were generated in the past. The plurality of historical queries can comprise historical queries that were generated by the same entity as the entity that generated the query portion of the query data (e.g., the same user that generated the query portion of historical query data). Further, the plurality of historical queries can comprise historical queries that were generated by one or more other entities (e.g., other users that generated the query portion of historical query data).

In some embodiments, the computing system can determine that the attention index comprises the plurality of historical attention scores that were used a threshold number of times. For example, if the threshold number of times is ten the attention index would comprise the historical attention scores that were associated with portions of a context item that were used ten or more times and would not include the historical attention scores that were used less than ten times. Further, when generating the attention index, the average attention scores and/or the variance of attention scores associated with various portions of the context item can be stored.

The corresponding plurality of portions of the context item can be smaller in size than the context item. For example, if the context item is a document comprising 12,500 words, the corresponding plurality of portions of the context item that are associated with the plurality of historical tokens can comprise 500 words or some other number of words that is less than 12,500 words. By way of further example, if the context item is an audio-video segment that has a duration of sixty minutes, the corresponding plurality of portions of the context item that are associated with the plurality of historical tokens can comprise audio-video segments of two minutes or some other duration that is less than sixty minutes.

Further, the computing system can perform operations to determine the relevant query cluster based on comparing the query to each query cluster of the plurality of query clusters in the attention index. For example, the computing system can perform one or more operations to compare the query to each query cluster of the plurality of query clusters and determine the relevant query cluster that is within a predetermined range of similarity with respect to the query (e.g., the query cluster that most closely matches the query).

In some embodiments, the computing system can generate and/or determine a query embedding based on the query data. The query embedding can be generated, based on inputting the query data (e.g., query data comprising the query and/or the context item) into one or more machine-learned models that can be configured and/or trained to generate the query embedding based on input comprising the query data. The query embedding can be generated based on processing features of the query data and generating a query embedding that comprises a feature space (a plurality of feature vectors) that can represent features of the query data and has a lower dimensionality than the query data on which the query embedding is based.

Further, the computing system can generate and/or determine a plurality of query cluster embeddings based on the plurality of query clusters. The plurality of query cluster embeddings can be generated, based on inputting the plurality of query cluster embeddings into one or more machine-learned models that can be configured and/or trained to generate the plurality of query cluster embeddings based on input comprising the plurality of query cluster embeddings. The plurality of query cluster embeddings can be generated based on processing features of the plurality of query clusters and generating a plurality of query cluster embeddings that comprise feature spaces that represent features of the plurality of query clusters and have a lower dimensionality than the plurality of query clusters on which the plurality of query cluster embeddings are based. In some embodiments, the embeddings (e.g., the plurality of query embeddings and/or the plurality of query cluster embeddings) can be processed based on classifying, recognizing, and/or detecting semantic features of the plurality of query clusters. For example, the operations to process semantic features comprise determining the meanings of words and/or phrases, recognizing entities, determining sentiment, classifying and/or grouping topics and/or concepts, recognizing style and/or tone, determining causal relationships between events.

In some embodiments, the attention index can comprise an embeddings database that can be used to determine the relevant query cluster. The attention index can comprise the plurality of query cluster embeddings and the relevant query cluster can be determined based on comparing the query embedding to the plurality of query cluster embeddings in the attention index. For example, the attention index can be searched by comparing the query embedding to the plurality of query cluster embeddings in the attention index to determine a similarity between the query cluster embedding and the plurality of query cluster embeddings. The relevant query cluster can be based on the query cluster embedding that satisfies a similarity threshold of the query embedding associated with the query.

In some embodiments, determining the relevant query cluster can be based on and/or comprise searching an attention index. The attention index can be generated based on the performance of operations to optimize an arrangement of the plurality of historical queries and/or the plurality of historical attention scores to facilitate search and comparison operations. Further, the attention index can comprise the plurality of historical queries, the plurality of query clusters, and/or the plurality of historical attention scores. The attention index can be configured to generate output comprising a relevant query cluster that satisfies a similarity threshold of the query.

In some embodiments, the attention index can be searched based on the use of a search algorithm that can be used to search the plurality of query clusters and/or the plurality of historical queries. The search algorithm can use a Euclidean distance, cosine similarity, nearest neighbor algorithm (e.g., k-nearest neighbor algorithm or a scalable nearest neighbor algorithm), and/or a hashing algorithm (e.g., locality-sensitive hashing). For example, the determination of the relevant query cluster that is within a similarity threshold of the query can be based on the Euclidean distance (e.g., the Euclidean distance between a query cluster and a query is inversely correlated with similarity such that a low Euclidean distance is associated with a high similarity). By way of further example, the determination of the relevant query cluster that is within a similarity threshold of the query can be based on the cosine similarity (e.g., the cosine similarity between a query cluster and a query is positively correlated with similarity such that high cosine similarity is associated with a high similarity).

In some embodiments, the plurality of query clusters and/or the plurality of query cluster embeddings can be stored in a lookup table. Further, the lookup table can be included in an attention index that is used to compare a query to the plurality of query clusters, or to compare a query embedding to the plurality of query embeddings.

The computing system can determine and/or generate a plurality of relevant tokens.

Determining the plurality of relevant tokens can be based on the plurality of tokens associated with the relevant query cluster. Further, the plurality of relevant tokens can comprise the plurality of historical tokens associated with the plurality of historical attention scores that satisfy one or more attention criteria. Satisfying the one or more attention criteria can be based on a historical attention score of the plurality of historical attention scores exceeding an attention score threshold. For example, the computing system can determine that the plurality of relevant tokens comprise the plurality of tokens associated with attention scores that exceed an attention score threshold. In some embodiments, the one or more attention criteria can be based on an average attention score of the plurality of tokens and satisfying the one or more attention criteria can comprise the plurality of relevant tokens exceeding the average attention score.

The computing system can determine and/or generate one or more results associated with the query. Determining the one or more results associated with the query can be based on inputting the plurality of relevant tokens into one or more machine-learned models. For example, the computing system can implement one or more machine-learned models comprising a generative pre-trained transformer model that can receive input comprising the plurality of relevant tokens (e.g., tokens associated with a text based query). Based on processing the input to determine the one or more results that are associated with the plurality of tokens, the one or more machine-learned models can generate output comprising the one or more results associated with the query (e.g., one or more results comprising an explanation of a scientific article based on a query comprising a question about the main points of the scientific article). In some embodiments, the one or more results can comprise one or more portions of the context item.

For example, the one or more results can comprise textual excerpts from text-based context (e.g., a text-based context item), audio excerpts from audio context (e.g., an audio-based context item), video excerpts from video-based context (e.g., a video-based context item), and/or audio-video excerpts from audio-video-based context (e.g., an audio-video-based context item).

The computing system can generate and/or determine result data. Generating the result data can be based on the one or more results associated with the query. For example, the computing system can generate result data comprising the one or more results associated with the query requesting the main points of the scientific article. The result data can comprise text-based results (e.g., text that is outputted to a display device), audio based results (e.g., synthetic speech that outputs text-based results in the form of audible synthetic speech), image-based results (e.g., images outputted to a display device), video-based results (e.g., video that is outputted to a display device, and/or audio-video-based results (e.g., a combination of video that is outputted to a display device and audio that is outputted to an audio device).

In some embodiments, the computing system can generate an interface (e.g., a graphical user interface) to which the result data can be outputted. For example, the computing system can generate an interface within an application that is configured to output the one or more results in the result data. For example, in response to a query associated with explaining an algorithm in a research paper, the computing system can generate result data comprising a text-based and/or audio-based (e.g., synthetic speech output that is generated via an audio-output device associated with the computing system) explanation of the algorithm in the research paper that was requested in the query. Further, the interface to which the result data can be outputted can be configured to display result data comprising images and/or video based on the result data and/or one or more portions of the context item associated with the result data.

The computing system can receive and/or obtain historical query data. The historical query data can comprise the plurality of historical queries. Further, the plurality of historical queries can be associated with corresponding plurality of portions of the context item. The historical query data can comprise a plurality of historical tokens based on the plurality of historical queries associated with the corresponding plurality of portions of the context item. For example, the computing system can receive query data that comprises a plurality of queries that are associated with the same context item (e.g., the same document or audio-video segment).

The computing system can generate and/or determine the plurality of query clusters. Generating the plurality of query clusters can be based on performing one or more clustering operations to cluster the plurality of historical queries based on a similarity to other historical queries of the plurality of historical queries, the plurality of query clusters. For example, the computing system can perform operations to cluster the plurality of historical queries based on comparing each of the plurality of historical queries to other historical queries of the plurality of historical queries and then clustering the historical queries with other historical queries that are similar.

The one or more clustering operations can comprise determining that the plurality of historical queries are assigned to and/or associated with the plurality of query clusters based on a similarity of an historical query of the plurality of historical queries being within the similarity threshold of a query cluster of the plurality of query clusters. For example, a numerical similarity value can be determined based on a comparison of a historical query to a query cluster. If the similarity value exceeds a similarity threshold, then the historical query can be assigned to and/or associated with the query cluster.

In some embodiments, performing the one or more clustering operations can comprise implementing one or more streaming algorithms. The one or more streaming algorithms can dynamically cluster the plurality of historical queries into clusters. As new queries are received, the new queries can be added to existing query clusters or new query clusters can be generated based on the new queries that are not within a similarity threshold of the existing query clusters.

In some embodiments, the one or more clustering operations can comprise determining a plurality of classes of the plurality of historical queries. For example, for a context item comprising a movie, the computing system can determine that the plurality of historical queries can be classified based on various factors including the movie character referred to in the query, the setting associated with a query, and/or the part of the movie referred to in the query.

Further, determining the plurality of classes of the plurality of historical queries can comprise implementing one or more machine-learned models that are configured and/or trained to determine a plurality of classes associated with the plurality of historical queries. In some embodiments, the one or more machine-learned models can be configured and/or trained to perform one or more natural language processing operations and/or semantic processing operations to determine the class of a historical query.

Further, the one or more clustering operations can comprise clustering the plurality of historical queries into the plurality of query clusters based on the plurality of classes associated with the plurality of historical queries. Further, the computing system can group historical queries that have the same class in the same cluster and cluster historical queries that have different classes into different clusters. For example, the computing system can determine that a new query cluster can be generated for historical queries that are in a class that is not within a similarity threshold of a query cluster (e.g., a historical query may be associated with a marine mammal class and the plurality of query clusters may not comprise a marine mammal class).

Further, the computing system can determine that a query that satisfies the similarity threshold (e.g., a similarity threshold based on the similarity of the class of a query to the class of a query cluster) can be added to a query cluster that is of the same or similar class. For example, a query that is classified as being associated with a particular character in a movie can be clustered into a query cluster that is classified as being associated with the same character in the movie. By way of further example, a query that is classified as being associated with fish can be clustered into a query cluster that is classified as being associated with marine life.

The computing system can generate and/or determine the plurality of historical attention scores based on the plurality of historical tokens associated with the plurality of historical queries corresponding to the plurality of query clusters. For example, based on historical queries associated with a particular document, the computing system can generate a plurality of historical attention scores based on the plurality of historical tokens derived from the plurality of historical queries associated with that particular document.

The computing system can generate and/or determine the attention index comprising the plurality of query clusters and/or the plurality of historical attention scores associated with the plurality of query clusters. For example, the computing system can generate an attention index in which the plurality of historical attention scores are arranged in a multi-dimensional array comprising one or more dimensions associated with the plurality of historical attention scores and one or more dimensions associated with the plurality of query clusters.

The computing system can receive and/or obtain an indication that the result data is insufficient. The indication that the result data is insufficient can be associated with result data that is inaccurate, irrelevant, too broad, or too narrow. Further, the computing system that generates the result data (e.g., a smartphone and/or laptop computing device that displays the result data in a graphical user interface) can generate a prompt that requests whether the result data is insufficient. Based on a response to the prompt (e.g., a user indicating via an interaction with an interface element that the result data is insufficient), the computing system can generate the indication that the result data is insufficient. For example, if query data comprised a query that requests a summary of a portion of a context item comprising a chapter of a book and the result data is associated with a different chapter of the book, feedback (e.g., a user indicating that the result data is not sufficiently relevant or accurate; and/or a machine-learned model that is configured and/or trained to determine whether the result data is relevant or accurate with respect to the query data) indicating that the result data is insufficient can be provided and sent to the computing system.

The computing system can modify the one or more attention criteria. Further, the computing system can modify the one or more attention criteria based on the indication that the result data is insufficient. For example, based on the indication that the result data is insufficient, the computing system can perform one or more operations to modify an attention score threshold that is used to determine the relevant query cluster that satisfies the attention score threshold with respect to the query (e.g., the query cluster that most closely matches the query). Modifying the one or more attention criteria can comprise increasing an attention score threshold that is associated with a minimum attention score that satisfies the one or more attention criteria. For example, based on receiving an indication that the result data is insufficient, the computing system can increase the attention score threshold such that a higher attention score is required to satisfy the attention score threshold.

In some embodiments, modification of the one or more attention criteria can be performed recursively or iteratively. Further, the one or more attention criteria can be modified multiple times until the result data is determined to be sufficient. In some embodiments, the one or more attention criteria can be modified each time that an indication that the result data is insufficient is received. Further, the one or more attention criteria can be gradually modified (e.g., an attention score threshold associated with the one or more attention criteria can be increased or decreased) until the attention scores satisfy the updated attention score threshold.

For example, if query data comprises a query requesting information that focuses on chapter three of a context item comprising a book and the result data comprises broad results that do not focus on chapter three of the book, then the one or more attention criteria can be modified to provide more focused results (e.g., results that are more narrowly directed to chapter three of the book) and/or result data (e.g., the attention score threshold can be increased to require higher attention scores to satisfy the threshold). By way of further example, if query data comprises a query requesting information that focuses on a general theme of a context item comprising a movie and the result data comprises very narrow results that focus on minor themes that are associated with a few characters or scenes in the movie without addressing a general theme of the movie, then the one or more attention criteria can be modified to provide broader results and/or result data.

The computing system can determine and/or generate a plurality of updated relevant tokens. The plurality of updated relevant tokens can comprise the plurality of tokens associated with the plurality of historical attention scores that satisfy the one or more attention criteria that were modified. For example, the computing system can determine that the plurality of updated relevant tokens comprise the plurality of tokens associated with attention scores that exceed a modified attention score threshold associated with the one or more attention criteria that were modified.

The computing system can determine and/or generate one or more updated results associated with the query. Determining the one or more updated results can be based on inputting the plurality of updated relevant tokens into the one or more machine-learned models. The one or more updated results can be associated with the query (e.g., the query associated with the result data that caused the indication that the result data is insufficient to be generated). For example, the computing system can implement one or more machine-learned models that can receive input comprising the plurality of updated relevant tokens. Based on processing the input to determine the one or more updated results that are associated with the plurality of updated tokens, the one or more machine-learned models can generate output comprising the one or more updated results associated with the query (e.g., one or more updated results comprising an analysis of an article in a journal based on a query comprising a question about a key technology described in the article).

The computing system can generate updated result data based on the one or more updated results associated with the query. For example, the computing system can generate updated result data comprising one or more updated results that are based on receiving an indication that the result data is insufficient. Further, in response to receiving an indication that the result data is insufficient based on the result data being too broad or not sufficiently addressing the query, the computing system can generate updated result data based on a plurality of relevant tokens that satisfy a higher attention score threshold. The updated result data can be generated within an interface (e.g., a graphical user interface) that can be displayed on a display output device. In some embodiments, the updated result data can be generated via an audio output device (e.g., one or more loudspeakers). For example, the computing system can generate synthetic speech based on text based result data that is then outputted via the audio output device.

The computing system can determine whether the query matches (e.g., directly matches) a historical query of the plurality of historical queries associated with the plurality of query clusters. For example, the computing system can determine whether the query directly matches a historical query by comparing the query to each historical query of the plurality of query clusters. In some embodiments, the computing system can determine whether the query satisfies a matching threshold (e.g., satisfying the matching threshold can require a greater degree of similarity between the query and the historical query than satisfying the similarity threshold for a query and a query cluster) of a historical query. Based on the query directly matching or being within a matching threshold of a historical query (e.g., with reference to characters in a book, the query “WHEN DID THE PROTAGONIST MEET THE ANTAGONIST FOR THE FIRST TIME?”) the computing system can determine that there is a direct match between the query and a historical query. By way of further example, with reference to characters in a book the query “WHEN DID THE PROTAGONIST MEET THE ANTAGONIST FOR THE FIRST TIME?” could be determined to match the historical query “WHEN DID THE PROTAGONIST FIRST MEET THE ANTAGONIST?” even though the query and the historical query are not exactly the same.

The computing system can add the query and the plurality of tokens associated with the query to a query cluster of the plurality of query clusters that is within the similarity threshold of the query and does not comprise a query that directly matches or is within a matching threshold the query. For example, based on the query not directly matching or being within a matching threshold a historical query (e.g., the query “WHEN DID THE PROTAGONIST MEET THE ANTAGONIST FOR THE FIRST TIME” being similar to but not directly matching the historical query “WHEN DOES THE PROTAGONIST MEET THE ANTAGONIST?), the server computing system can determine that there is not a direct match between the query and a historical query. The computing system can generate a query cluster (e.g., a new query cluster) that comprises a query that is not within the similarity threshold of the plurality of query clusters. For example, based on the query (e.g., a new query) not satisfying the similarity threshold due to the query not being associated with a portion of the context item that is addressed by any query cluster of the plurality of query clusters, the computing system can generate a query cluster comprising the query.

In some embodiments, the one or more machine-learned models can comprise one or more transformer models. The one or more transformer models can be configured and/or trained to generate the one or more results associated with the query based on input comprising the plurality of relevant tokens associated with the relevant query cluster, one or more portions of the query data (e.g., the query and/or the context item), and/or the query embedding. The one or more transformer models can be configured and/or trained to generate the query embedding based on the query. Further, the one or more transformer models can be configured and/or trained to generate the plurality of query cluster embeddings based on the plurality of query clusters.

In some embodiments, the one or more machine-learned models can comprise one or more large language models (LLMs). The one or more LLMs can be configured and/or trained to generate the one or more results associated with the query based on input comprising the plurality of relevant tokens associated with the relevant query cluster, one or more portions of the query data, and/or the query embedding.

The computing system can train, based on the plurality of historical queries (e.g., historical queries comprising and/or associated with a plurality of historical tokens) and/or the plurality of context items, the one or more machine-learned models to generate a plurality of results associated with the plurality of historical queries. Training the one or more machine-learned models can comprise modifying a plurality of parameters of the one or more machine-learned models to minimize a loss associated with a relevance of the plurality of results with respect to the plurality of historical queries.

The one or more machine-learned models can be configured and/or trained to generate the plurality of query clusters based on a similarity between two or more historical queries. For example, the one or more machine-learned models can be configured and/or trained to recognize the similarity between historical queries based on various features of the queries including the classes of the queries and/or the context items associated with the queries. In some embodiments, the one or more machine-learned models can be configured and/or trained to generate the plurality of results based on detecting, recognizing, or classifying features (e.g., visual features, spatial features, audio features, temporal features, and/or motion features) of the plurality of image context items, video context items, audio context items, and/or audio-video context items. Further, the one or more machine-learned models can be configured and/or trained to generate the plurality of results based on detecting, recognizing, or classifying features (e.g., textual features and/or semantic features) of the plurality of video context items and/or audio-video context items.

After each of the plurality of iterations, a loss associated with the accuracy of the output generated by the one or more machine-learned models can be generated (e.g., a loss that is inversely correlated with the accuracy of the output of the one or more machine-learned models). The weights of the parameters that contribute to decreasing the loss can be increased and the weights of the parameters that do not contribute to decreasing the loss or that increase the loss can be decreased. The one or more machine-learned models can be trained until some threshold accuracy level (e.g., 0.98 on a scale of 0.0 to 1.0 in which 1.0 is the highest accuracy and 0.0 is the lowest accuracy) is achieved.

In some embodiments, training the one or more machine-learned models can comprise receiving training data comprising the plurality of historical queries, the plurality of context items, and a corresponding plurality of ground-truth results associated with the plurality of historical queries and/or the plurality of context items. Further, training the one or more machine-learned models can comprise determining, based on inputting the training data comprising the plurality of historical queries and the plurality of context items into the one or more machine-learned models, a plurality of predicted results. Further, training the one or more machine-learned models can comprise determining a loss based on one or more differences between the plurality of predicted results and the corresponding plurality of ground-truth results. Further, training the one or more machine-learned models can comprise modifying a plurality of parameters of the one or more machine-learned models to minimize the loss associated with the predicted results. Further, the loss can increase in proportion to the magnitude of differences between the plurality of predicted results and the corresponding plurality of ground-truth results. For example, a predicted result that is slightly different from a corresponding ground-truth result can result in a smaller loss than a predicted result that is significantly different from a ground-truth result.

The systems, methods, devices, apparatuses, and tangible non-transitory computer-readable media in the disclosed technology can provide a variety of technical effects and benefits including improving the efficiency of computing and storage resource utilization as well as improving the performance of computing systems. In particular, the disclosed technology can generate an attention index that can include clusters of similar queries and their corresponding attention scores. Comparing queries to query clusters means that the tokens based on the portions of context (e.g., a context item) that are relevant can be used as an input to a machine-learned model instead of the entire context (e.g., context item), which can reduce the size of the context (e.g. context item) that is used as an input to the machine-learned model and result in a significant reduction in the wasteful use of computational resources associated with processing irrelevant tokens. Additionally, reducing the size of the context (e.g., reducing the size of a query and/or context item) can reduce latency, thereby reducing the time to receive results, which frees up computational resources for other tasks. Further, the one or more machine-learned models can use self-attention techniques which can scale quadratically with the context length (e.g., the number of tokens associated with the context which can include a query and/or context item). As a result, linear reductions in the context length can result in supra-linear reductions in the use of computational resources.

Further, the disclosed technology can improve the efficiency of processing new queries associated with contexts (e.g., context items) by comparing new queries to query clusters. If a new query is similar to a query cluster, the tokens associated with the context (e.g., context item) of the query cluster can be used instead of the entire context (e.g., context item) associated with the new query. As a result, the search space associated with the query can be reduced, thereby preserving computational resources.

Further, the disclosed technology can determine that the tokens of the query cluster that meet attention criteria (e.g., attention scores that exceed an attention score threshold) can be used as input to a machine-learned model that processes the query. This input can be smaller in size than the context (e.g., context item) associated with the new query, thereby reducing the computational burden and latency associated with processing a query and associated context (e.g., context item).

Further, in some embodiments, the disclosed technology can improve the performance of computing systems by generating query embeddings that can be compared to an attention index to provide more relevant search results, thereby reducing the need to perform additional searches. The query embeddings can reduce the number of redundant searches and reduce excessive use of computational resources when processing queries and/or contexts (e.g., context items).

As such, the disclosed technology may assist the user of a computing device that implements a machine-learning system in more effectively performing a variety of tasks directed to processing queries and/or contexts (e.g., context items) with the specific benefits of improved efficiency of resource utilization and improved computational performance. Further, any of the specific benefits provided to users can be used to improve the effectiveness of a wide variety of devices and services including computing devices and/or various types of applications including search applications and applications that implement machine-learned models. Accordingly, the improvements offered by the disclosed technology can result in tangible benefits to a variety of devices and/or systems including mechanical, electronic, and computing systems that can leverage the benefits of novel techniques to generate and search an attention index based on clustering similar queries and associated contexts (e.g., context items) that can be used to improve the efficiency of searches and provide more relevant search results.

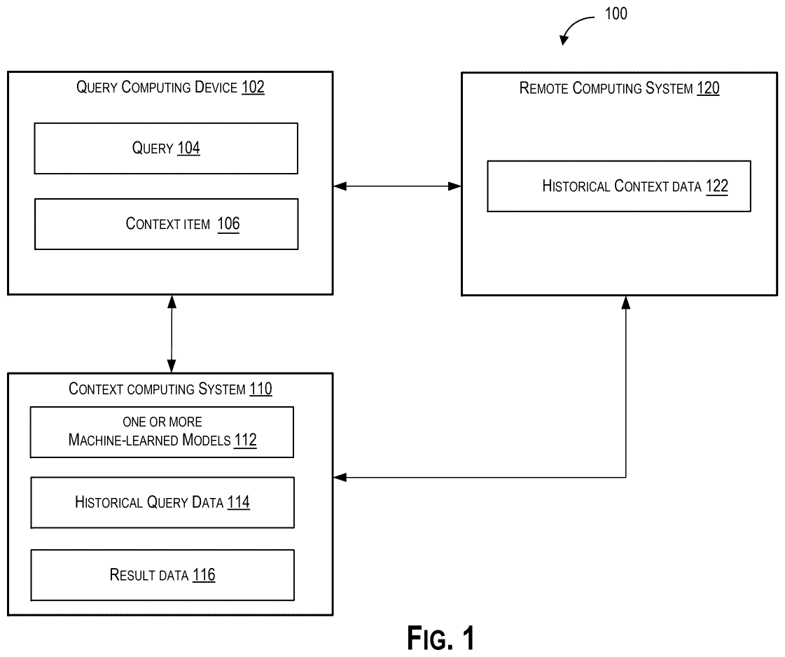

With reference now to the figures, example embodiments of the present disclosure will be discussed in further detail. FIG. 1 depicts a block diagram of examples of operations performed by a context processing system according to example embodiments of the present disclosure. One or more operations described with respect to a system 100 can be executed and/or implemented on one or more computing devices or computing systems comprising, for example, the computing device 50, the server computing system 60, the model development platform system 70, and/or the computing device 300. Further, one or more portions of the operations described with respect to the system 100 can be executed or implemented as an algorithm on the hardware devices or systems disclosed herein.

A query computing device 102 (e.g., a laptop computing device and/or a smartphone) can be used to generate the query 104 which can be associated with the context item 106. For example, the query computing device 102 can execute an application (e.g., a software application) that can receive a query 104. The query 104 can comprise a question associated with a context item 106 that comprises a video of a debate between multiple candidates for the office of mayor in a city. The query computing device 102 can generate query data that comprises the query 104 and the context item 106. The query computing device 102 can then send, via a network (e.g., a wireless network), the query data comprising the query 104 and/or the context item 106 to the context computing system 110.

The context computing system 110 can receive the query data comprising the query 104 and/or the context item 106. Based on the query data, the context computing system 110 can determine a relevant query cluster associated with the query and determine a plurality of relevant tokens associated with the relevant query cluster. Further, the context computing system 110 can determine the relevant query cluster based on comparing the query 104 to historical query data 114 which can comprise a plurality of query clusters. Further, the plurality of query clusters of the historical query data 114 can be associated with one or more portions of context items that can be stored in the context computing system 110 or in the historical context data 122 that is stored in the remote computing system 120. In some embodiments, the historical context data 122 can be stored in the context computing system 110 and/or some other computing system.

The context computing system 110 can access the historical context data 122 and generate the plurality of query clusters of the historical query data 114 based on determining the portions of context items that are associated with each historical query of the plurality of historical queries. Further, the context computing system 110 can implement one or more machine-learned models 112 (e.g., one or more LLMs configured and/or trained to process the query 104). Based on inputting the query 104 into the one or more machine-learned models 112, the one or more machine-learned models 112 can generate result data 116 which can comprise one or more results associated with the query 104. The context computing system 110 can then send the result data 116 to the query computing device 102. The query computing device 102 can execute an application that comprises an interface (e.g., a graphical user interface) that can display the result data 116.

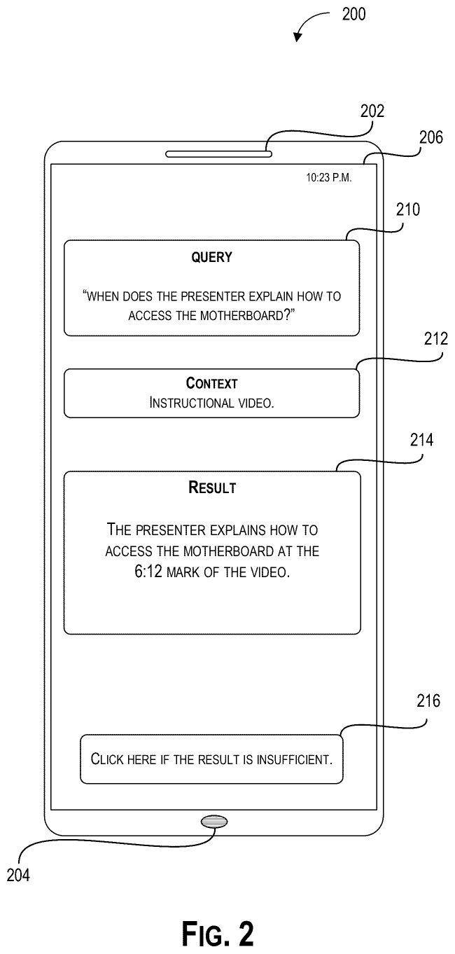

FIG. 2 depicts an example of an interface that displays a query and results associated with the query according to example embodiments of the present disclosure. A computing device 200 can include one or more features and/or capabilities of the computing device 50, the server computing system 60, the model development platform system 70, and/or the computing device 300.

The computing device 200 can include an audio output component 202, an audio input component 204, a display component 206, a query indication 210, a context indication 212, result data indication 214, and a feedback interface element 216.

The computing device 200 (e.g., a smartphone) can be configured to perform one or more operations comprising sending, receiving, processing, and/or generating data associated with query data and/or context data (e.g., context item data). Further, the computing device 200 can be configured to receive the query indication 210 and generate result data associated with the result data indication 214.

In this example, the computing device 200 has received the query indication 210 via the display component 206, which comprises a touch sensitive display component and can generate an onscreen keyboard that can be used to enter the query indication 210. In some embodiments, the query indication 210 can be inputted into the computing device 200 via the audio input component 204 (e.g., a microphone) that can be used to detect speech that can be recognized by the computing device 200. The query indication 210 indicates “WHEN DOES THE PRESENTER EXPLAIN HOW TO ACCESS THE MOTHERBOARD?” which was inputted into the computing device 200 via the onscreen keyboard (not shown) that was generated and removed from view after the result data indication 214 was generated. The query indication 210 can be associated with context (e.g., a context item) that is indicated by the context indicator 212. In this example, the context indicator 212 indicates that the context item is an “INSTRUCTIONAL VIDEO” that shows the steps to install various components (e.g., a solid state drive, RAM, and/or wireless network card) in a laptop computing device.

The computing device 200 can generate query data based on the query indication 210 and the context item associated with the context indication 212. Further, the computing device 200 can send the query data to a remote computing system that can process the query data and send result data (e.g., result data that can be indicated in the result data indication 214) to the computing device 200. In some embodiments, the computing device 200 can process the query data and generate the result data which can be indicated in the result data indication 214.

In this example, the result data indication 214 comprises the one or more results which indicate “THE PRESENTER EXPLAINS HOW TO ACCESS THE MOTHERBOARD AT THE 6:12 MARK OF THE VIDEO.” In some embodiments, the result data indication 214 can comprise audio that can be outputted via the audio output component 202 (e.g., a loudspeaker). For example, the computing device 200 can generate audio based on transcription of the result data which can be outputted via a synthetic voice that is generated by the computing device 200.

If the result data indication 214 indicates that the result data associated with the result data indication 214 is insufficient to address the query indication 210, the feedback interface element 216 (e.g., a graphical user interface element) can be used (e.g., the feedback interface element 216 can be configured to respond to a touch) to indicate that the result data in the result data indication 214 is insufficient. For example, based on a determination (e.g., a determination by a user) that the result data associated with the result data indication 214 is insufficient (e.g., too broad or too narrow), the feedback interface element 216 can be activated (e.g., activated based on one or more touch inputs) and the computing device 200 can generate updated result data. If the result data indicated in the result data indication 214 is irrelevant, inaccurate, too narrow, or too broad, the feedback interface element 216 can be used to cause the computing device 200 to generate updated result data. For example, if the result data indication 214 was deemed to be missing important information such as not indicating the tools required to access the motherboard the computing device 200 can cause the generation of updated relevant tokens associated with the query data that can be used to generate updated result data. For example, to address the missing information regarding the required tools that were not indicated in the result data indication 214, the updated result data can indicate “THE PRESENTER INDICATES THE TOOLS REQUIRED TO ACCESS THE MOTHERBOARD AT 1:10 AND EXPLAINS HOW TO ACCESS THE MOTHERBOARD AT THE 6:12 MARK OF THE VIDEO.”

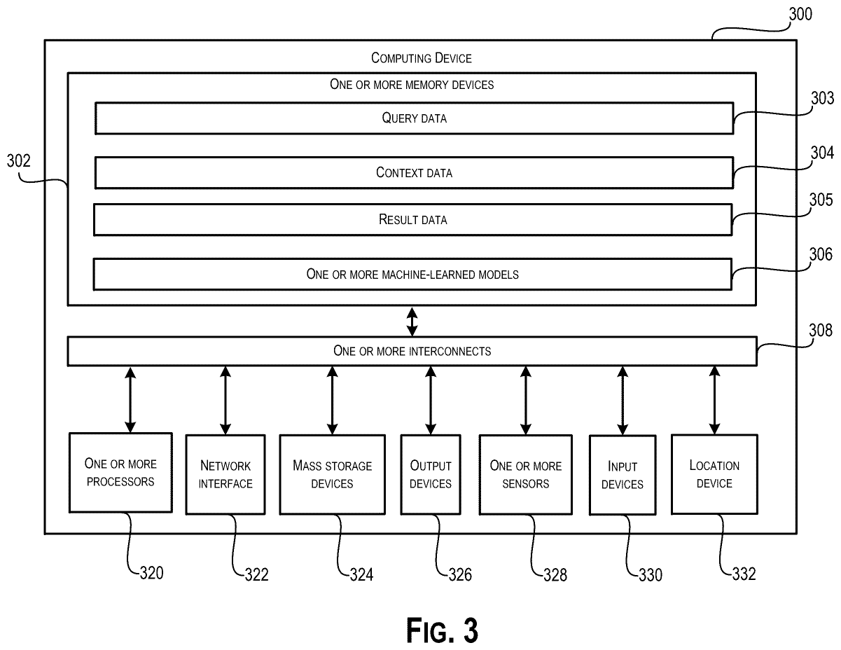

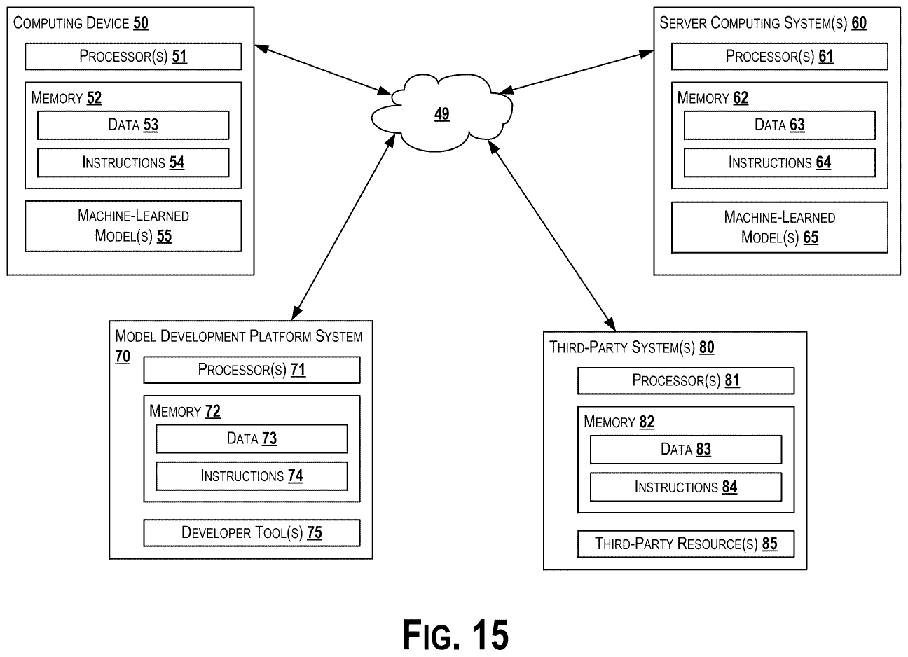

FIG. 3 depicts an example of a computing device according to example embodiments of the present disclosure. A computing device 300 can include one or more features and/or capabilities of the computing device 50, the server computing system 60, and/or the model development platform system 70. Furthermore, the computing device 300 can perform one or more actions and/or operations performed by the computing device 50, the server computing system 60, and/or the model development platform system 70, which are described with respect to FIG. 15.

As shown in FIG. 3, the computing device 300 can include one or more memory devices 302, query data 303, context data 304, result data 305, one or more machine-learned models 306, one or more interconnects 308, one or more processors 320, a network interface 322, one or more mass storage devices 324, one or more output devices 326, one or more sensors 328, one or more input devices 330, and/or the location device 332. The computing device 300 can be configured as a desktop computing device and/or a mobile computing device (e.g., a smartphone, tablet computing device, and/or laptop computing device). Further, the computing device 300 can process and/or generate data (e.g., result data) based on data (e.g., query data and/or context data) of the computing device 300 and/or data that is received from another computing device (e.g., query data and/or context data that is generated by a remote computing device).

The one or more memory devices 302 can store information and/or data (e.g., the query data 303, the context data 304, the result data 305, and/or the one or more machine-learned models 306). Further, the one or more memory devices 302 can include one or more computer-readable mediums (e.g., tangible non-transitory computer-readable media), including RAM, ROM, EEPROM, EPROM, flash memory devices, magnetic disks, and combinations thereof.

The information and/or data stored by the one or more memory devices 302 can be executed by the one or more processors 320 to cause the computing device 300 to perform operations including receiving query data comprising a query and context, determining a relevant query cluster that satisfies a similarity threshold of the query, determining tokens comprising the historical tokens associated with attention scores that satisfy attention criteria, determining results based on inputting the relevant tokens into the machine-learned models, and generating result data based on the results associated with the query.

The query data 303 can include, be included in, and/or be associated with one or more portions of data (e.g., the data 53, the data 63, and/or the data 73, which are depicted in FIG. 15) and/or one or more instructions (e.g., the instructions 54, the instructions 64, and/or the instructions 74 which are depicted in FIG. 15) that are stored in the memory 52, the memory 62, and/or the memory 72, respectively. The query data 303 can comprise one or more queries and/or context (e.g., a context item) that can be associated with the queries. For example, the query data 303 can comprise one or more search queries associated with a context. Further, the query data 303 can comprise one or more portions of the context data 304. In some embodiments, the query data 303 can be received from one or more computing systems (e.g., the computing device 50 and/or the server computing system 60 that is depicted in FIG. 15) which can include one or more computing systems that are remote from the computing device 300.

The context data 304 (e.g., context item data) can include, be included in, and/or be associated with one or more portions of data (e.g., the data 53, the data 63, and/or the data 73, which are depicted in FIG. 15) and/or instructions (e.g., the instructions 54, the instructions 64, and/or the instructions 74 which are depicted in FIG. 15) that are stored in the memory 52, the memory 62, and/or the memory 72, respectively. In some embodiments, the context data 304 can be received from one or more computing systems (e.g., the server computing system 60 that is depicted in FIG. 15) which can include one or more computing systems that are remote from the computing device 300. The context data 304 can comprise various types of context (e.g., various types of context items0. For example, the context data 304 can comprise one or more image context items (e.g., images from image repositories), one or more textual context items (e.g., text from document repositories), one or more audio context items (e.g., audio from audio databases), one or more video context items (e.g., video from video streaming sites), and/or one or more audio-video context items (e.g., video context that comprises audio). In some embodiments, one or more portions of the context data 304 can be included in the query data 303.

The result data 305 can include, be included in, and/or be associated with one or more portions of data (e.g., the data 53, the data 63, and/or the data 73, which are depicted in FIG. 15) and/or instructions (e.g., the instructions 54, the instructions 64, and/or the instructions 74 which are depicted in FIG. 15) that are stored in the memory 52, the memory 62, and/or the memory 72, respectively. Furthermore, the result data 305 can include information associated with the query and/or the context. For example, the result data 305 can comprise search results that are generated based on the query data 303 and/or the context data 304. In some embodiments, the result data 305 can be received from one or more computing systems (e.g., the server computing system 60 that is depicted in FIG. 15) which can include one or more computing systems that are remote from the computing device 300.

The one or more machine-learned models 306 (e.g., the one or more machine-learned models 55, the one or more machine-learned models 65, and/or the machine-learned models 75) can include, be included in, and/or be associated with one or more portions of the data 53, the data 63, and/or the data 73 which are depicted in FIG. 15 and/or instructions (e.g., the instructions 54, the instructions 64, and/or the instructions 74 which are depicted in FIG. 15) that are stored in the memory 52, the memory 62, and/or the memory 72, respectively. Furthermore, the one or more machine-learned models 306 can be configured and/or trained to perform operations comprising receiving query data comprising a query and context, determining a relevant query cluster that satisfies a similarity threshold of the query, determining tokens comprising the historical tokens associated with attention scores that satisfy attention criteria, determining results based on inputting the relevant tokens into the machine-learned models, and generating result data based on the results associated with the query. In some embodiments, the one or more machine-learned models 306 can be received from one or more computing systems (e.g., the server computing system 60 that is depicted in FIG. 15) which can include one or more computing systems that are remote from the computing device 300.

The one or more interconnects 308 can include one or more interconnects or buses that can be used to send and/or receive one or more signals (e.g., electronic signals) and/or data (e.g., the query data 303, the context data 304, the result data 305, and/or the one or more machine-learned models 306) between devices of the computing device 300, including the one or more memory devices 302, the one or more processors 320, the network interface 322, the one or more mass storage devices 324, the one or more output devices 326, the one or more sensors 328, and/or the one or more input devices 330. The one or more interconnects 308 can be arranged or configured in different ways, including as parallel or serial connections. Further the one or more interconnects 308 can include one or more internal buses to connect the internal components of the computing device 300; and one or more external buses used to connect the internal components of the computing device 300 to one or more external devices. By way of example, the one or more interconnects 308 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 320 can include one or more computer processors that are configured to execute the one or more instructions stored in the one or more memory devices 302. For example, the one or more processors 320 can, for example, include one or more general purpose central processing units (CPUs), application specific integrated circuits (ASICs), neural processing units (NPUs), and/or one or more graphics processing units (GPUs). Further, the one or more processors 320 can perform one or more actions and/or operations including one or more actions and/or operations associated with the query data 303, the context data 304, the result data 305, and/or the one or more machine-learned models 306. The one or more processors 320 can include single or multiple core devices including a microprocessor, microcontroller, integrated circuit, and/or a logic device.

The network interface 322 can support network communications. For example, the network interface 322 can support communication via networks including a local area network and/or a wide area network (e.g., the Internet). Further, the network interface 322 can be used to receive data (e.g., context data) from other computing devices. The one or more mass storage devices 324 (e.g., a hard disk drive and/or a solid-state drive) can be used to store data including the query data 303, the context data 304, the result data 305, and/or the one or more machine-learned models 306.

The one or more output devices 326 can include one or more display devices (e.g., LCD display, OLED display, Mini-LED display, microLED display, plasma display, and/or CRT display), one or more light sources (e.g., LEDs), one or more audio output devices (e.g., one or more loudspeakers), and/or one or more haptic output devices (e.g., one or more devices that are configured to generate vibratory output). For example, the one or more output devices 326 can comprise a touch sensitive display that is used to output an interface (e.g., a user interface) that can be configured to display indications based on the query data 303, the context data 304, and/or the result data 305.

The one or more sensors 328 can comprise one or more LiDAR devices, one or more sonar devices, one or more radar devices, one or more accelerometers, one or more gyroscopes, one or more altimeters, and/or one or more temperature sensors (e.g., one or more thermometers). The one or more input devices 330 can include one or more keyboards, one or more touch sensitive devices (e.g., a touch screen display), one or more buttons (e.g., a power button and/or volume buttons), one or more microphones, and/or one or more imaging devices (e.g., one or more cameras).

The one or more memory devices 302 and the one or more mass storage devices 324 are illustrated separately, however, the one or more memory devices 302 and the one or more mass storage devices 324 can be regions within the same memory module. The computing device 300 can include one or more additional processors, memory devices, and/or network interfaces, which can be provided separately or on the same chip or board. The one or more memory devices 302 and the one or more mass storage devices 324 can include one or more computer-readable media, including, but not limited to, non-transitory computer-readable media, RAM, ROM, hard drives, flash drives, and/or other memory devices.

The one or more memory devices 302 can store sets of instructions for applications including an operating system that can be associated with various software applications or data. For example, the one or more memory devices 302 can store sets of instructions for applications that can generate output that can include the result data 305. The one or more memory devices 302 can be used to operate various applications including a mobile operating system developed specifically for mobile devices. As such, the one or more memory devices 302 can store instructions that allow the software applications to access data including data associated with the processing of the query data 303, processing of the context data 304, implementation of machine-learned models 306, and/or the generation of result data 305. In other embodiments, the one or more memory devices 302 can be used to operate or execute a general-purpose operating system that operates on both mobile and stationary devices, including for example, smartphones, laptop computing devices, tablet computing devices, and/or desktop computers.

The software applications that can be operated or executed by the computing device 300 can include applications associated with the system 100 shown in FIG. 15. Further, the software applications that can be operated and/or executed by the computing device 300 can include native applications and/or web-based applications.

The location device 332 can include one or more devices or circuitry for determining the position of the computing device 300. For example, the location device 332 can determine an actual and/or relative position of the computing device 300 by using a satellite navigation positioning system (e.g., a GPS system, a Galileo positioning system, the GLObal Navigation satellite system (GLONASS), and/or the BeiDou Satellite Navigation and Positioning system), an inertial navigation system, a dead reckoning system, based on IP address, by using triangulation and/or proximity to cellular towers and/or Wi-Fi hotspots.

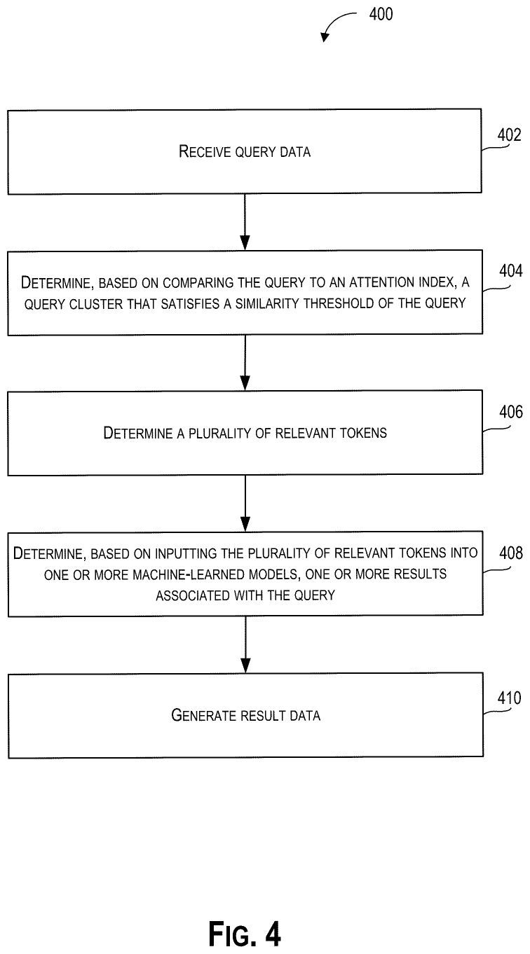

FIG. 4 depicts a flow chart diagram of an example method of processing contexts according to example embodiments of the present disclosure. One or more portions of the method 400 can be executed and/or implemented on one or more computing devices or computing systems comprising, for example, the computing device 50, the server computing system 60, the model development platform system 70, and/or the computing device 300.

Further, one or more portions of the method 400 can be executed or implemented as an algorithm on the hardware devices or systems disclosed herein. FIG. 4 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 402, the method 400 can include receiving query data comprising a query and a context item associated with the query, wherein the query data comprises a plurality of tokens based on the query and the context item. For example, the server computing system 60 can receive query data comprising a query that requests an explanation of a portion of a context item comprising a technical manual. The query data can be received from a local device (e.g., the server computing system 60) and/or from a remote source (e.g., the computing device 50) via a network such as the network 49. In some embodiments, the server computing system 60 can generate an interface (e.g., a graphical user interface) that can be displayed on a display component of a computing device that receives the query data. For example, the query data can comprise a query that is based on text that is displayed in a user interface of an application associated with a generative machine-learned model that is configured and/or trained to receive the query data and generate output comprising one or more results associated with a query included in the query data.

At 404, the method 400 can include determining, based on comparing the query to an attention index comprising a plurality of query clusters and a plurality of historical attention scores associated with the plurality of query clusters, a relevant query cluster that satisfies a similarity threshold of the query. The attention index can be based on historical query data comprising a plurality of historical tokens based on a plurality of historical queries associated with a corresponding plurality of portions of the context item. For example, the server computing system 60 can perform operations to determine the relevant query cluster based on comparing the query to each query cluster of the plurality of query clusters in the attention index. For example, the server computing system 60 can perform one or more operations to compare the query to the plurality of query clusters and determine the relevant query cluster that is within a predetermined range of similarity (e.g., within a similarity threshold) with respect to the query (e.g., the query cluster that most closely matches the query).

At 406, the method 400 can include determining, based on the plurality of tokens associated with the relevant query cluster, a plurality of relevant tokens comprising the plurality of historical tokens associated with the plurality of historical attention scores that satisfy one or more attention criteria. For example, the server computing system 60 can determine that the plurality of relevant tokens comprise the plurality of tokens associated with attention scores that exceed an attention score threshold.

At 408, the method 400 can include determining, based on inputting the plurality of relevant tokens into one or more machine-learned models, one or more results associated with the query. For example, the server computing system 60 can implement one or more machine-learned models (e.g., the one or more machine-learned models 65), that can receive input comprising the plurality of relevant tokens. Based on processing the input to determine the one or more results that are associated with the plurality of tokens, the one or more machine-learned models can generate output comprising the one or more results associated with the query (e.g., one or more results comprising an analysis of a portion of a movie based on a query comprising a question about a central theme of the movie).

At 410, the method 400 can include generating result data based on the one or more results associated with the query. For example, the server computing system 60 can generate result data comprising one or more results in response to a query requesting an explanation of a portion of a context item (e.g., one or more books and/or one or more magazine articles).

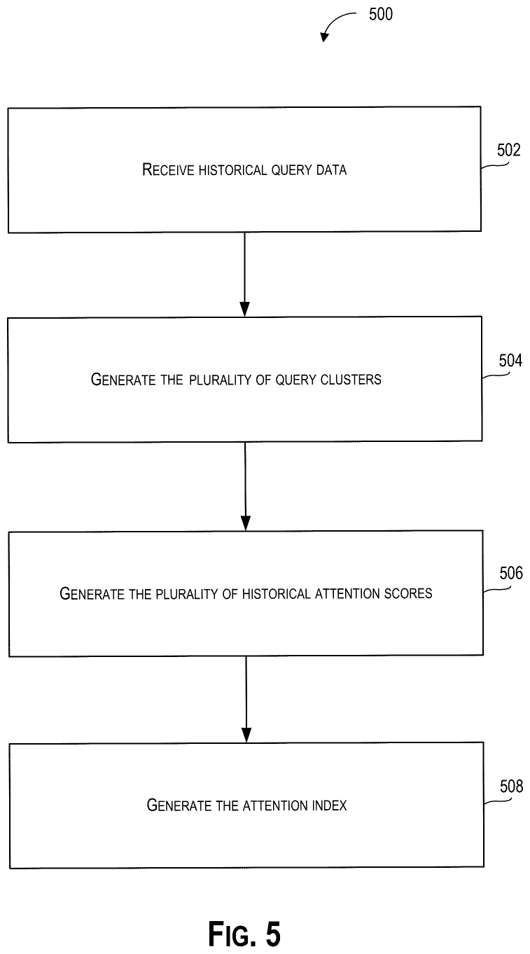

FIG. 5 depicts a flow chart diagram of an example method of processing contexts according to example embodiments of the present disclosure. One or more portions of the method 500 can be executed and/or implemented on one or more computing devices or computing systems comprising, for example, the computing device 50, the server computing system 60, the model development platform system 70, and/or the computing device 300.

Further, one or more portions of the method 500 can be executed or implemented as an algorithm on the hardware devices or systems disclosed herein. In some embodiments, one or more portions of the method 500 can be performed as part of the method 400 that is described with respect to FIG. 4. FIG. 5 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 502, the method 500 can include receiving historical query data comprising the plurality of historical queries associated with the corresponding plurality of portions of the context item. The historical query data can comprise a plurality of historical tokens based on the plurality of historical queries associated with the corresponding plurality of portions of the context item. For example, the server computing system 60 can receive query data comprising a plurality of queries that are associated with a single context item (e.g., a movie, television program, book, or piece of music). Further, the historical query data can be received from a local device (e.g., the server computing system 60) and/or from a remote source (e.g., the computing device 50) via a network such as the network 49. For example, the historical query data can comprise a query that is based on text that is displayed in a user interface of an application associated with a generative machine-learned model.

At 504, the method 500 can include generating, based on performing one or more clustering operations to cluster the plurality of historical queries based on a similarity to other historical queries of the plurality of historical queries, the plurality of query clusters. For example, the server computing system 60 can perform operations to cluster the plurality of historical queries based on comparing each of the plurality of historical queries to other historical queries of the plurality of historical queries. The historical queries that can be clustered with other historical queries that are similar. For example, the server computing system 60 can perform one or more operations to generate clusters of the plurality of historical queries in which each cluster is generated based on the similarity of the historical queries to other historical queries in the same cluster.

At 506, the method 500 can include generating the plurality of historical attention scores based on the plurality of historical tokens associated with the plurality of historical queries corresponding to the plurality of query clusters. For example, based on historical queries associated with a movie, the server computing system 60 can generate a plurality of historical attention scores based on the plurality of historical tokens derived from the plurality of historical queries.

At 508, the method 500 can include generating the attention index comprising the plurality of query clusters and the plurality of historical attention scores associated with the plurality of query clusters. For example, the server computing system 60 can generate an attention index comprising the plurality of query clusters and the plurality of historical attention scores associated with the plurality of query clusters.

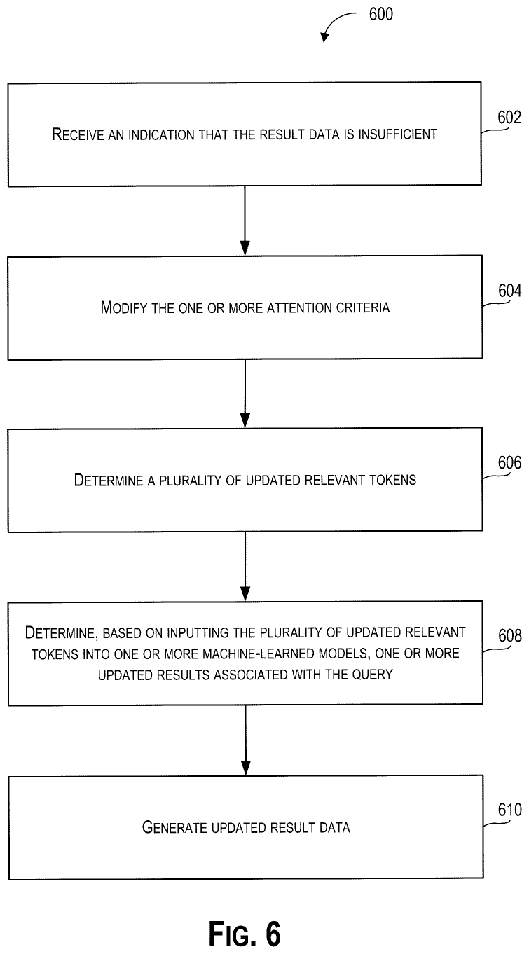

FIG. 6 depicts a flow chart diagram of an example method of processing contexts according to example embodiments of the present disclosure. One or more portions of the method 600 can be executed and/or implemented on one or more computing devices or computing systems comprising, for example, the computing device 50, the server computing system 60, the model development platform system 70, and/or the computing device 300.

Further, one or more portions of the method 600 can be executed or implemented as an algorithm on the hardware devices or systems disclosed herein. In some embodiments, one or more portions of the method 600 can be performed as part of the method 400 that is described with respect to FIG. 4. FIG. 6 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 602, the method 600 can include receiving an indication that the result data is insufficient. For example, the server computing system 60 can receive data comprising an indication that the result data is insufficient. The server computing system 60 can receive the indication that the result data is insufficient from the computing device 50. Further, the indication that the result data is insufficient can be based on feedback indicating that the result data is not sufficiently related to the query data comprising the query. For example, if query data comprises a query that requests an explanation of a portion of a context item comprising a particular portion of a video and the result data is associated with a different portion of the video, feedback indicating that the result data is insufficient can be provided and sent to the server computing system 60.

At 604, the method 600 can include modifying the one or more attention criteria. For example, the server computing system 60 can perform one or more operations to modify an attention score threshold that is used to determine the relevant query cluster that satisfies the attention score threshold.

At 606, the method 600 can include determining a plurality of updated relevant tokens comprising the plurality of tokens associated with the plurality of historical attention scores that satisfy the one or more attention criteria that were modified. For example, the server computing system 60 can determine that the plurality of updated relevant tokens comprise the plurality of tokens associated with attention scores that exceed a higher attention score threshold that is based on the one or more attention criteria that were modified.

At 608, the method 600 can include determining, based on inputting the plurality of updated relevant tokens into the one or more machine-learned models, one or more updated results associated with the query. For example, the server computing system 60 can implement one or more machine-learned models (e.g., the one or more machine-learned models 65), that can determine one or more updated results based on input comprising the plurality of updated relevant tokens.

At 610, the method 600 can include generating updated result data based on the one or more updated results associated with the query. For example, the server computing system 60 can generate updated result data comprising one or more updated results that are based on an indication that indicated that the result data is insufficient.

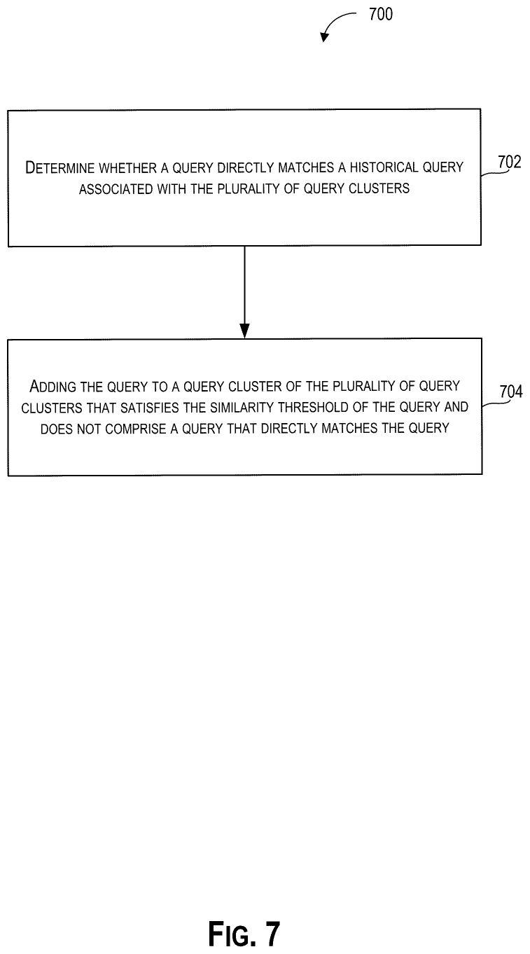

FIG. 7 depicts a flow chart diagram of an example method of processing contexts according to example embodiments of the present disclosure. One or more portions of the method 700 can be executed and/or implemented on one or more computing devices or computing systems comprising, for example, the computing device 50, the server computing system 60, the model development platform system 70, and/or the computing device 300.

Further, one or more portions of the method 700 can be executed or implemented as an algorithm on the hardware devices or systems disclosed herein. In some embodiments, one or more portions of the method 700 can be performed as part of the method 400 that is described with respect to FIG. 4. FIG. 7 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 702, the method 700 can include determining whether the query directly matches a historical query associated with the plurality of query clusters. For example, the server computing system 60 can determine whether the query directly matches a historical query by comparing the query to the plurality of query clusters. Based on the query directly matching a historical query (e.g., the query “WHEN DOES THE PROTAGONIST MEET THE ANTAGONIST FOR THE FIRST TIME” matching the same historical query), the server computing system can determine that there is a direct match between the query and a historical query.

At 704, the method 700 can include adding the query and the plurality of tokens associated with the query to a query cluster of the plurality of query clusters that satisfies a similarity threshold of the query and does not comprise a query that directly matches the query. For example, based on the query not directly matching a historical query (e.g., the query “WHEN DOES THE PROTAGONIST MEET THE ANTAGONIST FOR THE FIRST TIME” not matching a similar but differently worded historical query), the server computing system can determine that there is not a direct match between the query and a historical query.

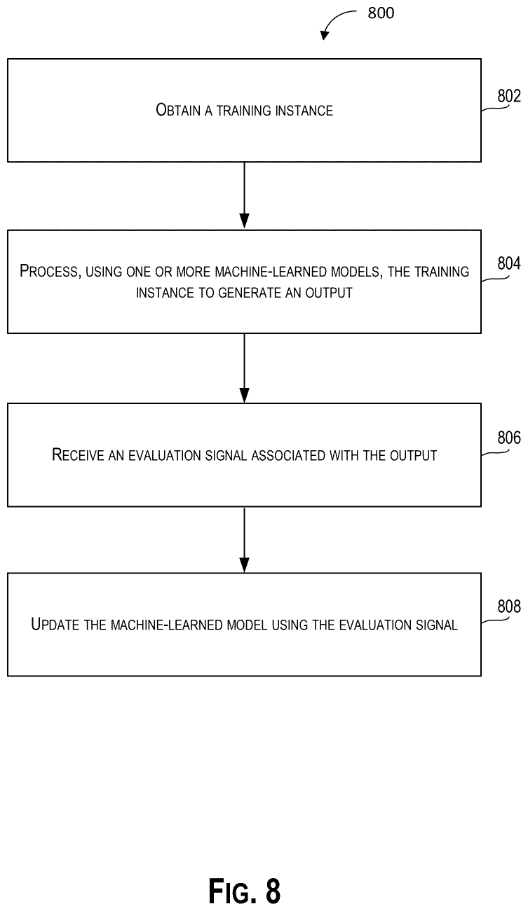

FIG. 8 depicts a flowchart of a method for training one or more machine-learned models according to aspects of the present disclosure. For instance, an example machine-learned model can include a query and context processing model that is configured and/or trained to generate results based on queries.

One or more portion(s) of example method 800 can be implemented by a computing system that includes one or more computing devices such as, for example, computing systems described with reference to the other figures. Each respective portion of example method 800 can be performed by any (or any combination) of one or more computing devices. Moreover, one or more portion(s) of example method 800 can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of example method 800 can be performed additionally, or alternatively, by other systems.

At 802, example method 800 can include obtaining a training instance. A set of training data can include a plurality of training instances divided between multiple datasets (e.g., a training dataset, a validation dataset, or testing dataset). A training instance can be labeled or unlabeled. Although referred to in example method 800 as a “training” instance, it is to be understood that runtime inferences can form training instances when a model is trained using an evaluation of the model's performance on that runtime instance (e.g., online training/learning).

Example data types for the training instance and various tasks associated therewith are described throughout the present disclosure. For example, the training instance can comprise a variety of historical queries that are associated with various context items.

At 804, example method 800 can include processing, using one or more machine-learned models, the training instance to generate an output. The output can be directly obtained from the one or more machine-learned models or can be a downstream result of a chain of processing operations that includes an output of the one or more machine-learned models.

At 806, example method 800 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning).

The evaluation signal can be a reward (e.g., for reinforcement learning). The reward can be computed using a machine-learned reward model configured to generate rewards based on output(s) received. The reward can be computed using feedback data describing human feedback on the output(s).

At 808, example method 800 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 800 can include implementing a number of generalization techniques (e.g., weight decays, dropouts, etc.) to improve the generalization capability of the models being trained.

In some implementations, example method 800 can be implemented for training a machine-learned model from an initialized state to a fully trained state (e.g., when the model exhibits a desired performance profile, such as based on accuracy, precision, recall, etc.).

In some implementations, example method 800 can be implemented for particular stages of a training procedure. For instance, in some implementations, example method 800 can be implemented for pre-training a machine-learned model. Pre-training can include, for instance, large-scale training over potentially noisy data to achieve a broad base of performance levels across a variety of tasks/data types.

In some implementations, the example method 800 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 800 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 800 can be implemented to execute parameter-efficient fine-tuning methods, such as Low-Rank Adaptation (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

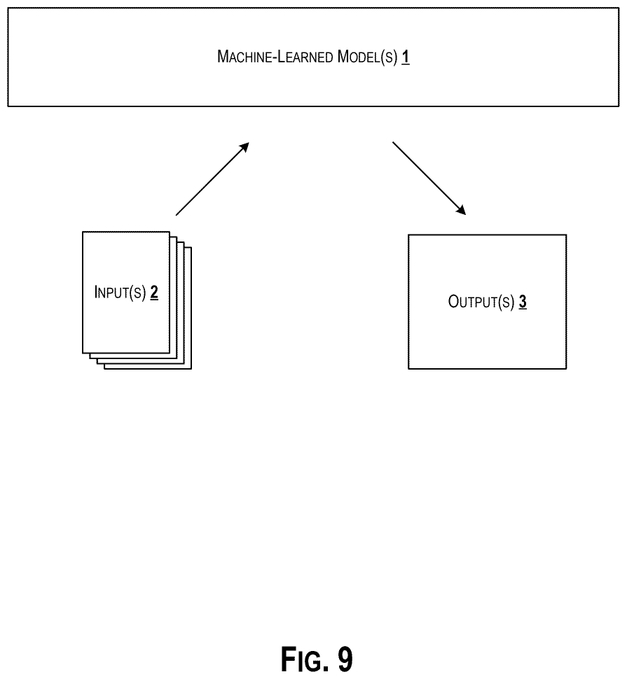

FIG. 9 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be, include, or otherwise be representative of any one or more of the machine-learned models described above with respect to the preceding figures. For example, machine-learned model(s) 1 can be or include, or otherwise be representative of any one or more of the machine-learned models described herein. Although various features, variations, and implementations described below are described with respect to machine-learned model(s) 1, it is to be understood that such features, variations, and implementations are to be understood as described with respect to each of the machine-learned components described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention.

For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, arXiv: 2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

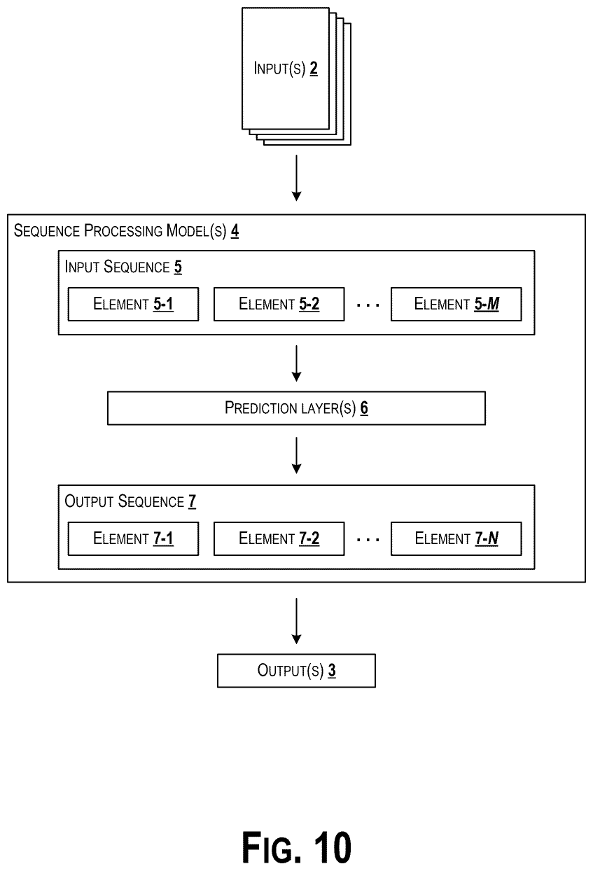

FIG. 10 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components.

Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information.

For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Large Language Models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, Google; and/or Gemma 2: Improving Open Language Models at a Practical Size, Google.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, Google; PaliGemma 2: A Family of Versatile VLMs for Transfer, Google; Flamingo: a Visual Language Model for Few-Shot Learning, Google; and/or PaLI: A Jointly-Scaled Multilingual Language-Image Model, Google.

Sequence processing model(s) 4 can be multimodal. Example multimodal sequence processing models include, for instance, models described in Gemini: A Family of Highly Capable Multimodal Models, Google; Gemini 1.5: Unlocking multimodal understanding across millions of tokens of context, Google.

Other example sequence processing models can operate to generate outputs or receive inputs in specific domains, such as image domains, see, e.g., Dosovitskiy et al., An Image is Worth 16×16 Words: Transformers for Image Recognition at Scale, arXiv: 2010.11929v2 (Jun. 3, 2021), audio domains, see, e.g., Agostinelli et al., MusicLM: Generating Music From Text, arXiv: 2301.11325v1 (Jan. 26, 2023), biochemical domains, see, e.g., Jumper et al., Highly accurate protein structure prediction with AlphaFold, 596 Nature 583 (Aug. 26, 2021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018). Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 10 can be the tokens or can be the embedded representations thereof.

Prediction layer(s) 6 can predict one or more output elements 7-1, 7-2,. 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.” A transformer is an example architecture that can be used in prediction layer(s) 4.

See, e.g., Vaswani et al., Attention Is All You Need, arXiv: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

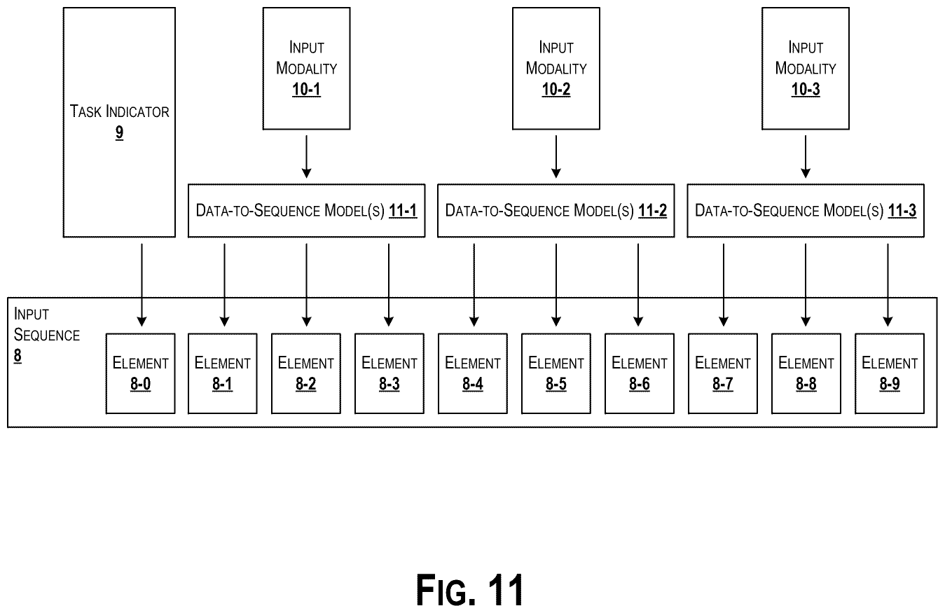

FIG. 11 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space.

For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.).

An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4.

Data-to-sequence models 11-1, 11-2, and 11-3 can be trained end-to-end with machine-learned sequence processing model(s) 4.

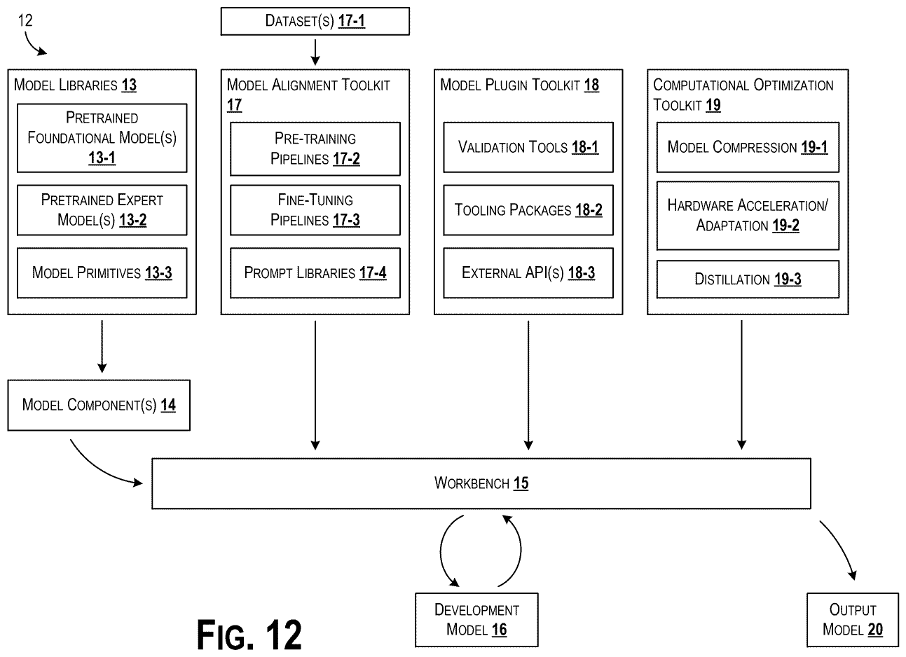

FIG. 12 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data.

Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data.

Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values.

Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 700 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models-e.g., understanding an intent in an unstructured request for a task-while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

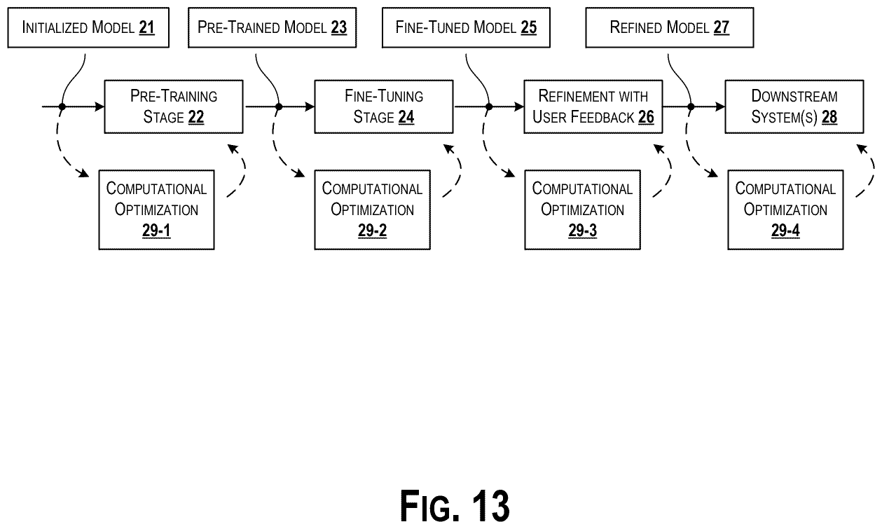

FIG. 13 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 13 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

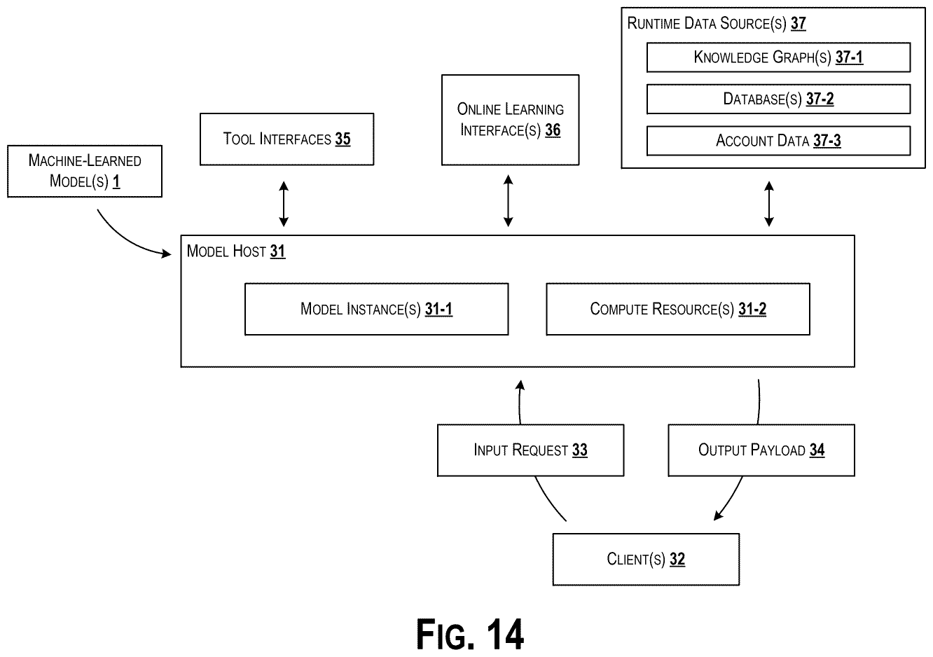

FIG. 14 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance.

Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34.

Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output.

As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data.

Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data.

Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc.

Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

FIG. 15 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 15 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52.

Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51.

Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and/or combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 15 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

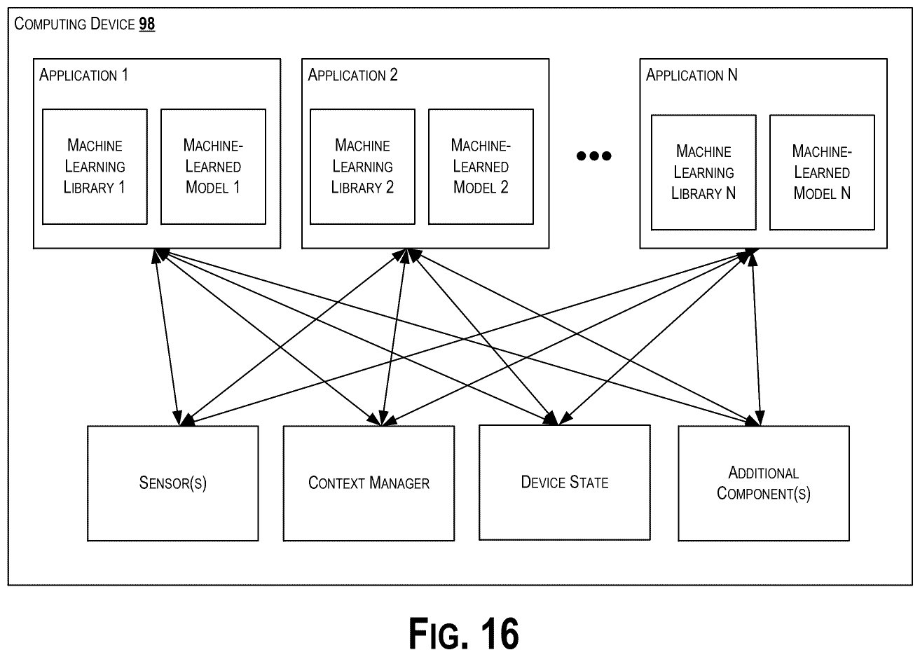

FIG. 16 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 16, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

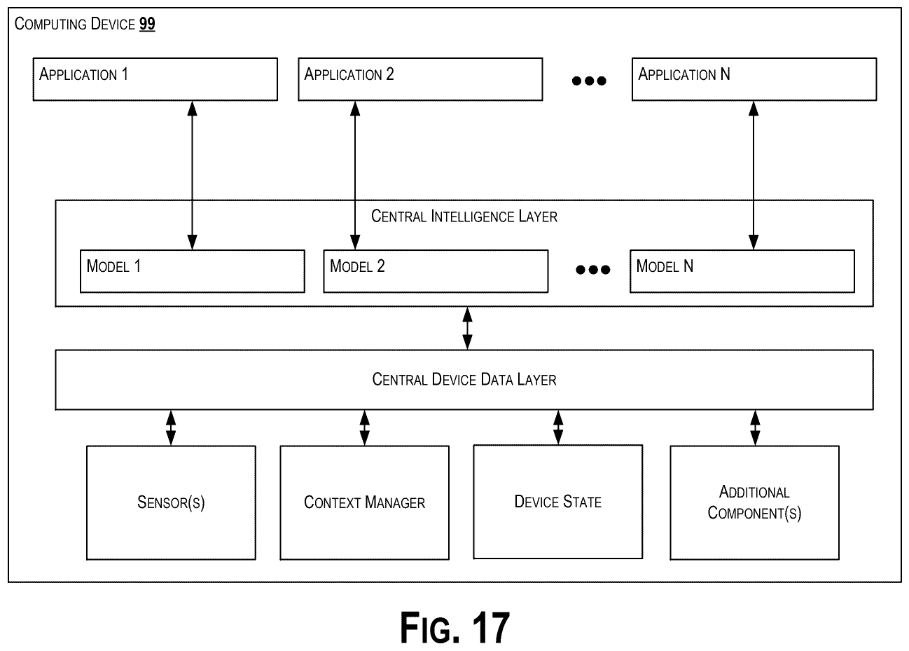

FIG. 17 is a block diagram of an example computing device 99 that performs according to example embodiments of the present disclosure. The computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 17, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 17, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of,” “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

1. A computer-implemented method of processing contexts, the computer-implemented method comprising:
receiving, by a computing system comprising one or more processors, query data comprising a query and a context item associated with the query, wherein the query data comprises a plurality of tokens based on the query and the context item;
determining, by the computing system, based on comparing the query to an attention index comprising a plurality of query clusters and a plurality of historical attention scores associated with the plurality of query clusters, a relevant query cluster that satisfies a similarity threshold of the query, wherein the plurality of query clusters are based on a plurality of historical queries associated with a plurality of historical tokens and a corresponding plurality of portions of the context item, and wherein the attention index comprises an average attention score associated with the corresponding plurality of portions of the context item;
determining, by the computing system, based on the plurality of tokens associated with the relevant query cluster, a plurality of relevant tokens comprising the plurality of historical tokens associated with the plurality of historical attention scores that satisfy one or more attention criteria based at least in part on the average attention score;
determining, by the computing system, based on inputting the plurality of relevant tokens into one or more machine-learned models, one or more results associated with the query; and
generating, by the computing system, result data based on the one or more results associated with the query.

2. The computer-implemented method of claim 1, further comprising:
receiving, by the computing system, historical query data comprising the plurality of historical queries associated with the corresponding plurality of portions of the context item, wherein the historical query data comprises the plurality of historical tokens based on the plurality of historical queries associated with the corresponding plurality of portions of the context item;
generating, by the computing system, based on performing one or more clustering operations to cluster the plurality of historical queries based on a similarity to other historical queries of the plurality of historical queries, the plurality of query clusters;
generating, by the computing system, the plurality of historical attention scores based on the plurality of historical tokens associated with the plurality of historical queries corresponding to the plurality of query clusters; and
generating, by the computing system, the attention index comprising the plurality of query clusters and the plurality of historical attention scores associated with the plurality of query clusters.

3. The computer-implemented method of claim 2, wherein the one or more clustering operations comprise implementation of one or more streaming algorithms.

4. The computer-implemented method of claim 2, wherein the one or more clustering operations comprise determining a plurality of classes of the plurality of historical queries, and wherein the one or more clustering operations comprise clustering the plurality of historical queries into the plurality of query clusters based on the plurality of classes of the plurality of historical queries.

5. The computer-implemented method of claim 4, wherein the one or more clustering operations comprise determining that the plurality of historical queries are assigned to the plurality of query clusters based on a similarity of an historical query of the plurality of historical queries being within the similarity threshold of a query cluster of the plurality of query clusters.

6. The computer-implemented method of claim 1, wherein the context item comprises an image, a text segment, a video segment, an audio segment, or an audio-video segment.

7. The computer-implemented method of claim 1, further comprising:
receiving, by the computing system, an indication that the result data is insufficient;
modifying, by the computing system, based on the indication that the result data is insufficient, the one or more attention criteria;
determining, by the computing system, a plurality of updated relevant tokens comprising the plurality of tokens associated with the plurality of historical attention scores that satisfy the one or more attention criteria that were modified;
determining, by the computing system, based on inputting the plurality of updated relevant tokens into the one or more machine-learned models, one or more updated results associated with the query; and
generating, by the computing system, updated result data based on the one or more updated results associated with the query.

8. The computer-implemented method of claim 7, wherein the modifying the one or more attention criteria comprises increasing an attention score threshold that is associated with a minimum attention score that satisfies the one or more attention criteria.

9. The computer-implemented method of claim 1, wherein the plurality of query clusters are stored in a lookup table.

10. The computer-implemented method of claim 1, wherein the satisfying the one or more attention criteria is based on a historical attention score of the plurality of historical attention scores exceeding an attention score threshold.

11. The computer-implemented method of claim 1, wherein the one or more machine-learned models comprise one or more transformer models.

12. The computer-implemented method of claim 1, wherein the query is associated with the context item comprising an audio-video segment, and wherein the corresponding plurality of portions of the context item comprise different portions of the audio-video segment.

13. The computer-implemented method of claim 1, wherein the query is associated with the context item comprising a text segment, and wherein the corresponding plurality of portions of the context item comprise different portions of the text segment.

14. The computer-implemented method of claim 1, further comprising:
determining, by the computing system, whether the query directly matches a historical query of the plurality of historical queries associated with the plurality of query clusters; and
adding, by the computing system, the query to a query cluster of the plurality of query clusters that satisfies the similarity threshold of the query and does not comprise a query that directly matches the query.

15. The computer-implemented method of claim 1, wherein the corresponding plurality of portions of the context item are smaller in size than the context item.

16. One or more tangible non-transitory computer-readable media storing computer-readable instructions that when executed by one or more processors cause the one or more processors to perform operations, the operations comprising:
receiving query data comprising a query and a context item associated with the query, wherein the query data comprises a plurality of tokens based on the query and the context item;
determining, based on comparing the query to an attention index comprising a multi-dimensional array comprising one or more dimensions associated with a plurality of query clusters and one or more dimensions associated with a plurality of historical attention scores associated with the plurality of query clusters, a relevant query cluster that satisfies a similarity threshold of the query, wherein the plurality of query clusters are based on a plurality of historical queries associated with a plurality of historical tokens and a corresponding plurality of portions of the context item;
determining, based on the plurality of tokens associated with the relevant query cluster, a plurality of relevant tokens comprising the plurality of historical tokens associated with the plurality of historical attention scores that satisfy one or more attention criteria;
determining, based on inputting the plurality of relevant tokens into one or more machine-learned models, one or more results associated with the query; and
generating result data based on the one or more results associated with the query.

17. The one or more tangible non-transitory computer-readable media of claim 16, wherein the satisfying the one or more attention criteria is based on a historical attention score of the plurality of historical attention scores exceeding an attention score threshold.

18. A computing system comprising:
one or more processors;
one or more non-transitory computer-readable media storing instructions that when executed by the one or more processors cause the one or more processors to perform operations comprising:
receiving query data comprising a query and a context item associated with the query, wherein the query data comprises a plurality of tokens based on the query and the context item;
determining, based on comparing the query to an attention index comprising a multi-dimensional array comprising one or more dimensions associated with a plurality of query clusters and one or more dimensions associated with a plurality of historical attention scores associated with the plurality of query clusters, a relevant query cluster that satisfies a similarity threshold of the query, wherein the plurality of query clusters are based on a plurality of historical queries associated with a plurality of historical tokens and a corresponding plurality of portions of the context item;
determining, based on the plurality of tokens associated with the relevant query cluster, a plurality of relevant tokens comprising the plurality of historical tokens associated with the plurality of historical attention scores that satisfy one or more attention criteria;
determining, based on inputting the plurality of relevant tokens into one or more machine-learned models, one or more results associated with the query; and
generating result data based on the one or more results associated with the query.

19. The computing system of claim 18, wherein the satisfying the one or more attention criteria is based on a historical attention score of the plurality of historical attention scores exceeding an attention score threshold.

20. The computing system of claim 18, wherein the query is associated with the context item comprising an audio-video segment, and wherein the corresponding plurality of portions of the context item comprise different portions of the audio-video segment.
